(19) United States
(12) Patent Application Publication
(10) Pub. No.: US 2025/0292058 A1
(43) Pub. Date: Sep. 18, 2025

(54) MULTI-MATERIAL CARDS WITH ANTENNAS

(71) Applicant: JPMORGAN CHASE BANK, N.A., New York, NY (US)

(72) Inventors: James KRAUSE, Long Island City, NY (US); Katarina GOIS, New York, NY (US)

(21) Appl. No.: 19/080,099

(22) Filed: Mar. 14, 2025

Related U.S. Application Data
(60) Provisional application No. 63/565,870, filed on Mar. 15, 2024.
(60) Provisional application No. 63/674,608, filed on Jul. 23, 2024.

(51) Int. Cl. G06K 19/077; G06K 19/06

(52) U.S. Cl. CPC G06K 19/07775; G06K 19/06187; G06K 19/07722

(57) ABSTRACT

Multi-material cards with antennas are disclosed. A transaction card may include a card substrate having an antenna recess; an antenna received in the antenna recess; a chip opening in the antenna recess; a chip received in the chip opening, wherein the antenna is in electrical communication with the chip; and a non-blocking material positioned over the chip and the antenna in the antenna recess; wherein the non-blocking material allows radio frequency waves to pass to the antenna.

### RELATED APPLICATIONS

This application claims priority to U.S. Provisional Patent Application Ser. No. 63/565,870, filed Mar. 15, 2024, and U.S. Provisional Patent Application Ser. No. 63/674,608, filed Jul. 23, 2024, the disclosure of each of which is hereby incorporated, by reference, in its entirety.

### BACKGROUND OF THE INVENTION

### 1. Field of the Invention

Embodiments are generally directed to multi-material cards with antennas.

### 2. Description of the Related Art

Full metal cards without plastic laminate exist. The metal in such cards, however, blocks communication with the antenna, thereby hindering contactless payments.

### SUMMARY OF THE INVENTION

Multi-material cards with antennas are disclosed. In one embodiment, a transaction card may include a card substrate having an antenna recess; an antenna received in the antenna recess; a chip opening in the antenna recess; a chip received in the chip opening, wherein the antenna is in electrical communication with the chip; and a non-blocking material positioned over the chip and the antenna in the antenna recess; wherein the non-blocking material allows radio frequency waves to pass to the antenna.

In one embodiment, the card substrate may include a material that blocks radio frequency communication.

In one embodiment, the card substrate may include a metal.

In one embodiment, the antenna may include an antenna array.

In one embodiment, the chip may include electrical contacts that are accessible through the chip opening.

In one embodiment, the transaction card may also include a magnetic stripe.

According to another embodiment, a transaction card may include: a first card substrate layer; a second card substrate layer; an antenna positioned between the first card substrate layer and the second card substrate layer, the antenna located on a perimeter of the first card substrate layer and the second card substrate layer; a chip opening in the first card substrate layer; and a chip received in the chip opening, wherein the antenna is in electrical communication with the chip.

In one embodiment, the card substrate may include a material that blocks radio frequency communication.

In one embodiment, the card substrate may include a metal.

In one embodiment, the antenna may include an antenna array.

In one embodiment, the chip may include electrical contacts that are accessible through the chip opening.

According to another embodiment, a transaction card may include: a first card substrate layer having a chip opening; a second card substrate layer having an antenna recess, the antenna recess having an antenna opening; a non-blocking material positioned in the antenna recess; an antenna received in the antenna recess; and a chip received in the chip opening, wherein the antenna is in electrical communication with the chip; wherein the non-blocking material and the antenna opening allows radio frequency waves to pass to the antenna.

In one embodiment, the card substrate may include a material that blocks radio frequency communication.

In one embodiment, the card substrate may include a metal.

In one embodiment, the antenna may include an antenna array.

In one embodiment, the chip may include electrical contacts that are accessible through the chip opening.

In one embodiment, the transaction card may also include a magnetic stripe.

### BRIEF DESCRIPTION OF THE DRAWINGS

For a more complete understanding of the present invention, the objects and advantages thereof, reference is now made to the following descriptions taken in connection with the accompanying drawings in which:

FIG. 1 depicts a multi-material card with an antenna according to an embodiment;

FIG. 2 depicts a multi-material card with an antenna according to another embodiment;

FIG. 3 depicts a multi-material card with an antenna according to another embodiment;

FIG. 4 depicts a multi-material card with an antenna according to another embodiment; and

FIGS. 5A and 5B depict a multi-material card with an antenna according to another embodiment;

### DETAILED DESCRIPTION OF PREFERRED EMBODIMENTS

Multi-material cards with antennas are disclosed. Embodiments may include a card of a substrate, such as a metal, having an antenna array positioned thereon, such as in an indentation in the substrate. The antenna array may include a plurality of antenna loops.

In embodiments, a material that does not block radio frequency communication with the antenna array may cover the antenna array. The material may allow for radio frequency communication with the antenna array. The material may be adhered to the substrate using an adhesive and ultraviolet curing, heat pressing, etc.

Different sizes of materials may be used. The size may depend on the size of the antenna array.

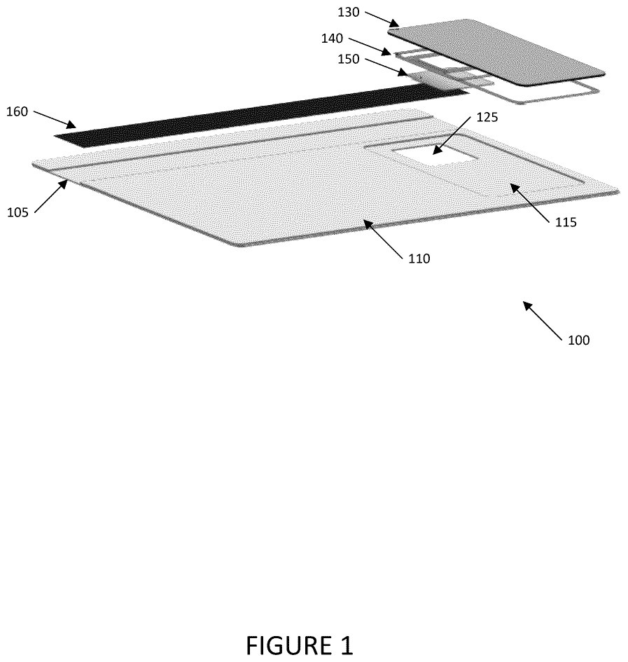

Referring to FIG. 1, a multi-material card with an antenna is disclosed according to an embodiment. FIG. 1 depicts an exploded view of multi-material card 100 from the rear of multi-material card 100.

Multi-material card 100 may include card substrate 110, such as a metal or other material that may block or reduce the transmission of radio frequency communications. Multi-material card 100 may include stripe recess 105 for receiving magnetic stripe 160. In one embodiment, magnetic stripe may be positioned on card substrate 110 without a recess, or may not be provided at all. Multi-material card 100 may further include antenna recess 115 in which antenna 140 may be received. Although FIG. 1 depicts one antenna 140, it should be noted that multiple antennas, and different antenna configurations, may be used as is necessary and/or desired.

Antenna recess 115 may be provided with chip opening 125 in which chip 150, such as a Europay, Mastercard, and Visa (EMV) chip, may be received. Chip 150 may be electrically connected to antenna 140. The contacts (now shown) of chip 150 may be accessible via chip opening 125 on the front side of multi-material card 100.

Once chip 150 and antenna 140 are received in antenna recess 115, non-blocking material 130 may be received into antenna recess 115 and may cover chip 150 and antenna 140. Non-blocking material 130 may be any suitable material that does not block radio frequency communication so that antenna 140 communicates with, for example, card reading devices.

Non-blocking material 130 may be secured to substrate 110 using an adhesive, heat pressing, ultraviolet curing, pressure, and/or combinations thereof, or by any suitable manner.

It should be noted that the size and orientation of antenna recess 115 may vary as is necessary and/or desired in order to accommodate different sizes, numbers, and configurations of antenna 140.

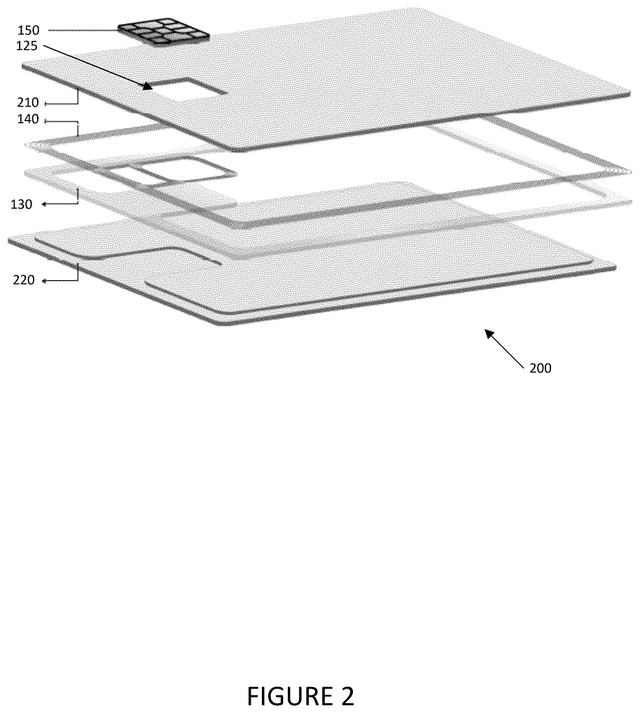

Referring to FIG. 2, a multi-material card with an antenna is disclosed according to another embodiment. FIG. 2 depicts an exploded view of multi-material card 200 from the front of multi-material card 200.

Multi-material card 200 may include first layer 210 and second layer 220 of a card substrate, such as a metal or other material that may block or reduce the transmission of radio frequency communications. Non-blocking material 130 may be provided between first layer 210 and second layer 220. Antenna 140 may be provided between first layer 210 or second layer 220 and non-blocking material 130. Chip 150 may be provided in chip opening 125 in first layer 210.

First layer 210, non-blocking material 130, and second layer 220 may be secured using an adhesive, heat pressing, ultraviolet curing, pressure, and/or combinations thereof, or by any suitable manner.

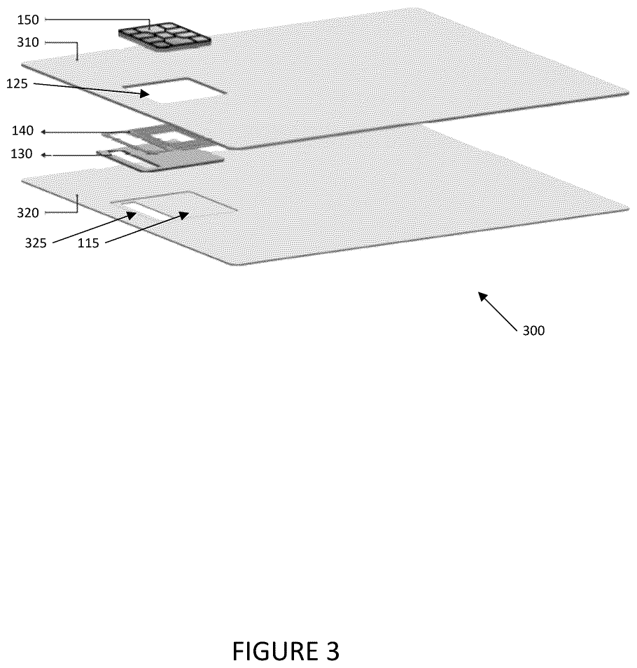

Referring to FIG. 3, a multi-material card with an antenna is disclosed according to another embodiment. FIG. 3 depicts an exploded view of multi-material card 300 from the front of multi-material card 300.

Multi-material card 300 may include first layer 310 and second layer 320 of a card substrate, such as a metal or other material that may block or reduce the transmission of radio frequency communications. Non-blocking material 130 may be provided in antenna recess 115 and may include an opening therein. Antenna 140 may be provided on non-blocking material 130, and may communicate with chip 150, that may be provided in chip opening 125 in first layer 310.

In one embodiment, second layer 320 may include antenna opening 325 that may allow radio communications to pass to antenna 140.

First layer 310, non-blocking material 130, and second layer 320 may be secured using an adhesive, heat pressing, ultraviolet curing, pressure, and/or combinations thereof, or by any suitable manner.

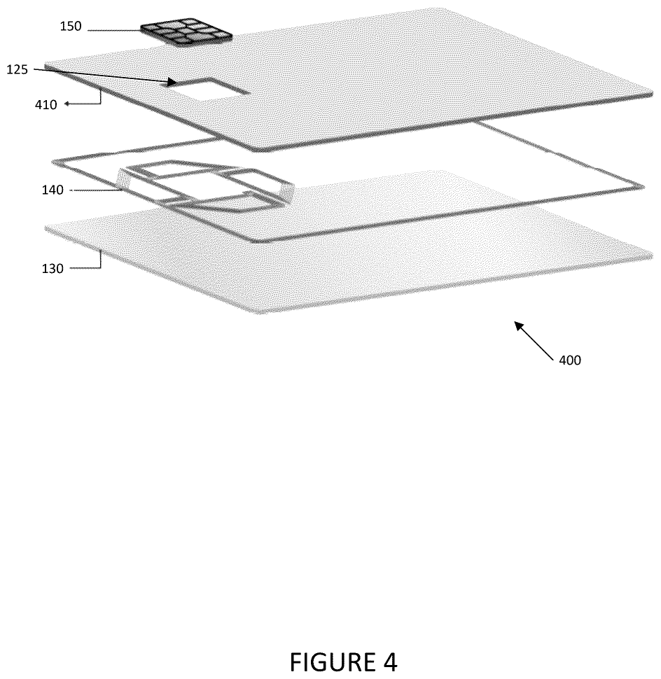

Referring to FIG. 4, a multi-material card with an antenna is disclosed according to another embodiment. FIG. 4 depicts an exploded view of multi-material card 400 from the front of multi-material card 400.

Multi-material card 300 may include first layer 410 and second layer 420 of a card substrate, such as a metal or other material that may block or reduce the transmission of radio frequency communications. Antenna 140 may be provided between first layer 410 and second layer 420 along the perimeter such that antenna 140 may communicate via radio frequency communication. Antenna 140 may communicate with chip 150, that may be provided in chip opening 125 in first layer 310.

First layer 410, antenna 140, and second layer 420 may be secured using an adhesive, heat pressing, ultraviolet curing, pressure, and/or combinations thereof, or by any suitable manner.

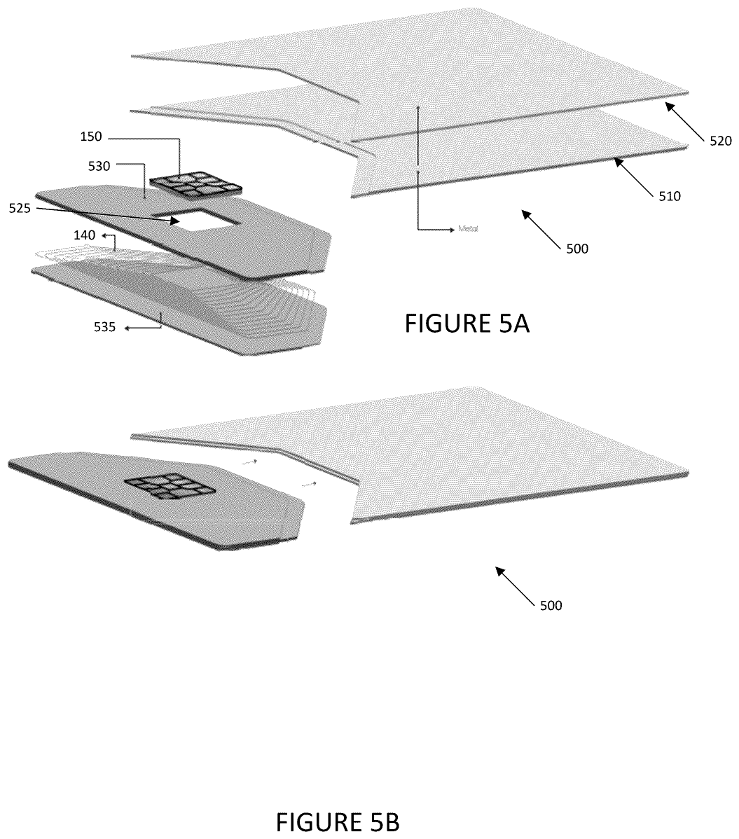

Referring to FIGS. 5A and 5B, a multi-material card with an antenna is disclosed according to another embodiment. FIG. 5A depicts an exploded view of multi-material card 500 from the front of multi-material card 500.

Multi-material card 500 may include first layer 510 and second layer 525 of a card substrate, such as a metal or other material that may block or reduce the transmission of radio frequency communications. Multi-material card 500 may also include first layer of non-blocking material 530 and second layer of non-blocking material 535. Antenna 140 may be provided between first layer of non-blocking material 530 and second layer of non-blocking material 535 and may communicate with chip 150, that may be provided in chip opening 425 in first layer of non-blocking material 530.

In one embodiment, second layer 320 may include antenna opening 325 that may allow radio communications to pass to antenna 140

First layer 510 and second layer 520 may be secured using an adhesive, heat pressing, ultraviolet curing, pressure, and/or combinations thereof, or by any suitable manner. First layer of non-blocking material 530, antenna 140, and second layer of non-blocking material 535 may be secured using an adhesive, heat pressing, ultraviolet curing, pressure, and/or combinations thereof, or by any suitable manner. The assembly of first layer of non-blocking material 530, antenna 140, and second layer of non-blocking material 535 may be provided to the assembly of First layer 510 and second layer 520, and the assemblies may be secured using an adhesive, heat pressing, ultraviolet curing, pressure, and/or combinations thereof, or by any suitable manner. The assembly is depicted in FIG. 5B.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope. Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A transaction card, comprising:
a card substrate comprising an antenna recess;
an antenna received in the antenna recess;
a chip opening in the antenna recess;
a chip received in the chip opening, wherein the antenna is in electrical communication with the chip; and
a non-blocking material positioned over the chip and the antenna in the antenna recess;
wherein the non-blocking material allows radio frequency waves to pass to the antenna.

2. The transaction card of claim 1, wherein the card substrate comprises a material that blocks radio frequency communication.

3. The transaction card of claim 1, wherein the card substrate comprises a metal.

4. The transaction card of claim 1, wherein the antenna comprises an antenna array.

5. The transaction card of claim 1, wherein the chip comprises electrical contacts that are accessible through the chip opening.

6. The transaction card of claim 1, further comprising a magnetic stripe.

7. A transaction card, comprising:
a first card substrate layer;
a second card substrate layer;
an antenna positioned between the first card substrate layer and the second card substrate layer, the antenna located on a perimeter of the first card substrate layer and the second card substrate layer;
a chip opening in the first card substrate layer; and
a chip received in the chip opening, wherein the antenna is in electrical communication with the chip.

8. The transaction card of claim 7, wherein the card substrate comprises a material that blocks radio frequency communication.

9. The transaction card of claim 7, wherein the card substrate comprises a metal.

10. The transaction card of claim 7, wherein the antenna comprises an antenna array.

11. The transaction card of claim 7, wherein the chip comprises electrical contacts that are accessible through the chip opening.

12. A transaction card, comprising:
a first card substrate layer comprising a chip opening;
a second card substrate layer comprising an antenna recess, the antenna recess comprising an antenna opening;
a non-blocking material positioned in the antenna recess;
an antenna received in the antenna recess; and
a chip received in the chip opening, wherein the antenna is in electrical communication with the chip;
wherein the non-blocking material and the antenna opening allows radio frequency waves to pass to the antenna.

13. The transaction card of claim 12, wherein the card substrate comprises a material that blocks radio frequency communication.

14. The transaction card of claim 12, wherein the card substrate comprises a metal.

15. The transaction card of claim 12, wherein the antenna comprises an antenna array.

16. The transaction card of claim 12, wherein the chip comprises electrical contacts that are accessible through the chip opening.

17. The transaction card of claim 12, further comprising a magnetic stripe.
